(19) United States
(12) Patent Application Publication
(10) Pub. No.: US 2024/0401342 A1
(43) Pub. Date: Dec. 5, 2024

(54) BEVELED FLOOR PANEL

(71) Applicant: Keding Enterprises Co., Ltd, New Taipei City 241561 (TW)

(72) Inventor: Hsien-Chang Tsao, New Taipei City 241561 (TW)

(21) Appl. No.: 18/604,664

(22) Filed: Mar. 14, 2024

(30) Foreign Application Priority Data
May 31, 2023 (TW) 112205484

(51) Int. Cl. E04F 15/02; B32B 3/06; B32B 27/06; E04F 15/10

(52) U.S. Cl. CPC E04F 15/02033; B32B 3/06; B32B 27/06; E04F 15/02038; E04F 15/107; B32B 2250/03; B32B 2307/402; B32B 2307/554; B32B 2307/7376; B32B 2419/04; E04F 2201/0107; E04F 2201/023; E04F 2201/043

(57) ABSTRACT

A beveled floor panel includes a bottom layer and a floor layer. A lateral side of the bottom layer has a first connection portion and a second connection portion. The first connection portion is to be connected to a second connection portion of a second beveled floor panel. The second connection portion is to be connected to a first connection portion of the second beveled floor panel. The floor layer is disposed on the bottom layer, and has two or four top lateral edges each formed with a bevel. The floor layer includes a homochromatic layer and a wear-resistant printing layer disposed on the homochromatic layer. With this structure, either a color difference at a seam groove of the bevel can be reduced after the floor panels having different color systems have been spliced, or the problem of different colors can be reduced, and the appearance cannot be affected.

### BACKGROUND OF THE INVENTION

### (1) field of the Invention

This invention relates to a floor panel, and more particularly to an improved structure of a beveled floor panel, wherein the color difference at a seam groove of a bevel can be reduced after the floor panels having different color systems have been spliced, or the problem of different colors can be reduced, and the appearance cannot be affected.

### (2) Description of the Prior Art

Interlocking floor panels, also referred to as floating floor panels, have simple configurations and can be rapidly installed. Such the floor panels are designed such that they can be installed on other hard surfaces, such as concrete surfaces, ceramic tile surfaces or existing wood floor surfaces. Types of the interlocking floor panels mainly include a laminate flooring, a solid wood interlocking flooring and the like. The technological basic elements of the interlocking floor panel will be described in the following.

Regarding interlocking systems, keys of the interlocking floor panels reside in their interlocking systems. Edges of these floor panels are designed with special tenons and grooves to allow the panels to be tightly connected together without any glue or nail. Such the systems make the smooth installation of the floor panels possible, and the floor panels can also be easily removed or replaced when needed.

Regarding the material, the interlocking floor panels may be made of various materials, wherein the most common material is a laminate flooring composed of a wear-resistant printing layer, an image layer (used to imitate the outlook of wood or stone), a high density fiberboard (middle layer) and a bottom layer. A solid wood interlocking flooring is made of solid wood, and can provide the very natural outlook, but has the higher cost. A luxury vinyl flooring is made of a vinyl resin, can imitate various natural materials, and has a good durability and waterproof performance.

Regarding the installation, the installation of the interlocking floor panels is relatively simple and does not require any professional skill. In most cases, the user only needs to arrange the floor panels in a required pattern and directions, and then pushes the floor panels together, so that the interlocking systems between the floor panels tightly connect the floor panels together to form a smooth surface.

Regarding the maintenance, the maintenance of the interlocking floor panels is relatively easy. Most cleaning thereof may also be performed using the dry or slightly damp cloth. Some special cleaning products may also be needed, and the specific requirements depend on the material of the floor panel.

However, the drawbacks of the existing technology often lie in that the middle layer (non-PETG or ABS material) has the monotonous color, and that multiple colors of wear-resistant printing layers often cannot be configured to have the same color. Thus, after the floor panels have been spliced, the seam groove between the bevels often appears different colors, and the unsightly and uncoordinated visual effects are caused. More particularly, in order to cover up the color difference, a secondary process is performed using a color pen to manually paint the color, the same as that of the wear-resistant printing layer, onto the edge strips one by one. Therefore, in order to avoid this problem and trouble, when this type of printed flooring panel is designed, manufactured and produced, most of the products without bevels are produced.

Therefore, how to solve the above-mentioned conventional problems and drawbacks is the direction that the present inventor and those skilled in the art want to research and improve urgently.

### SUMMARY OF THE INVENTION

Therefore, the present inventor has collected relevant information, evaluated and considered many parties, and thus developed and designed the present invention to solve the above-mentioned drawbacks according to many years of experience in this filed through continuous trial production and modification.

An objective of the invention is to provide an improved beveled floor panel, wherein either the color difference at the seam groove of the bevel can be reduced after the floor panels having different color systems have been spliced, or the problem of different colors can be reduced, and the appearance cannot be affected.

To achieve the above-identified or other objectives, the invention provides an improved beveled floor panel. The beveled floor panel includes: a bottom layer, wherein a lateral side of the bottom layer has a first connection portion and a second connection portion, the first connection portion is to be connected to a second connection portion of a second beveled floor panel, and the second connection portion is to be connected to a first connection portion of the second beveled floor panel; and a floor layer, which is disposed on the bottom layer, and has two top lateral edges each formed with a bevel, wherein the floor layer includes a homochromatic layer and a wear-resistant printing layer, and the wear-resistant printing layer is disposed on the homochromatic layer.

In one preferred embodiment, a material of the bottom layer is a medium density fiberboard (MDF), a solid polymer core (SPC), polyvinyl chloride (PVC), foam or laminated veneer lumber.

In one preferred embodiment, a material of the homochromatic layer is polyethylene terephthalate glycol (PETG) or acrylonitrile butadiene styrene (ABS).

In one preferred embodiment, a material of the wear-resistant printing layer is polypropylene (PP), polyvinyl chloride (PVC) or paper. In one preferred embodiment, each of four top lateral edges of the floor layer is formed with a bevel.

In one preferred embodiment, the first connection portion is a male structure, and the second connection portion is a female structure connected to the male structure.

In one preferred embodiment, a depth of the bevel ranges between 0.05 mm and 0.8 mm.

In one preferred embodiment, a thickness of the bottom layer ranges between 1 mm and 25 mm.

In one preferred embodiment, a thickness of the homochromatic layer ranges between 0.2 mm and 1.0 mm.

In one preferred embodiment, a thickness of the wear-resistant printing layer ranges between 0.05 mm and 0.5 mm.

### BRIEF DESCRIPTION OF THE DRAWINGS

FIG. 1 is a first pictorial view showing an improved beveled floor panel according to a preferred embodiment of the invention.

FIG. 2 is a second pictorial view showing the improved beveled floor panel according to the preferred embodiment of the invention.

FIG. 3 is a pictorially exploded view showing the improved beveled floor panel according to the preferred embodiment of the invention.

FIG. 4 is a side view showing the improved beveled floor panel according to the preferred embodiment of the invention.

FIG. 5 is a schematic implementation view showing the improved beveled floor panel according to the preferred embodiment of the invention.

FIG. 6 is a schematic implementation view showing an improved beveled floor panel according to another preferred embodiment of the invention.

FIG. 7 is a schematic implementation view showing an improved beveled floor panel according to still another preferred embodiment of the invention.

### DETAILED DESCRIPTION OF THE PREFERRED EMBODIMENTS

In order to achieve the above-mentioned objectives and effects, the technical means and structures adopted in this invention are described in detail below with reference to drawings of the preferred embodiment of this invention to facilitate a complete understanding to this invention.

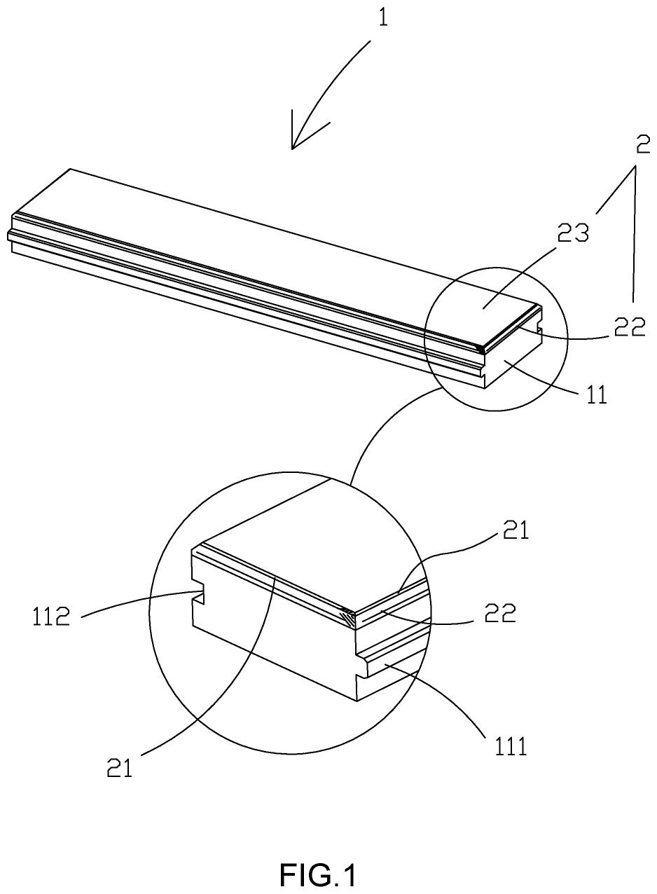

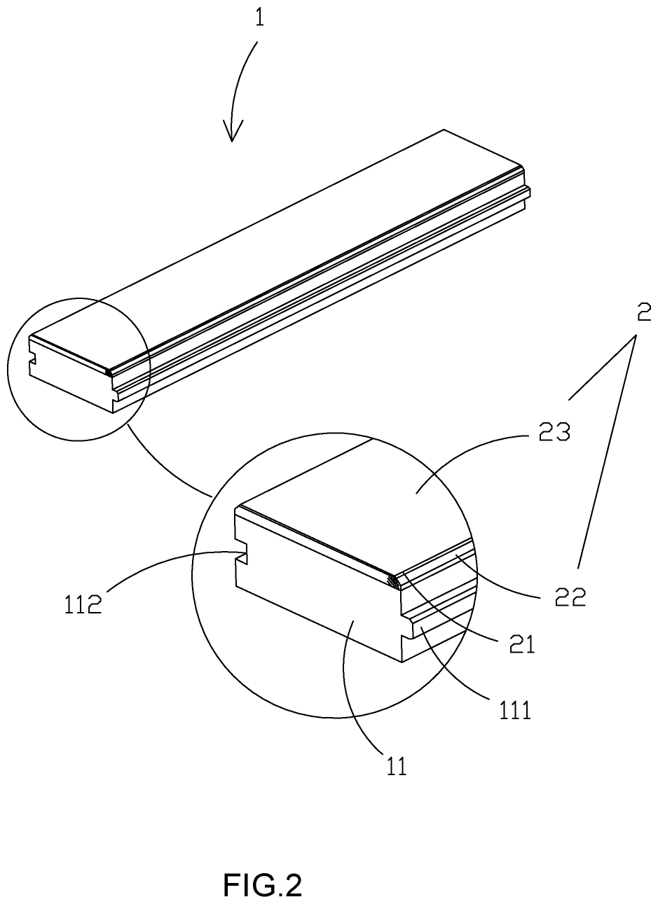

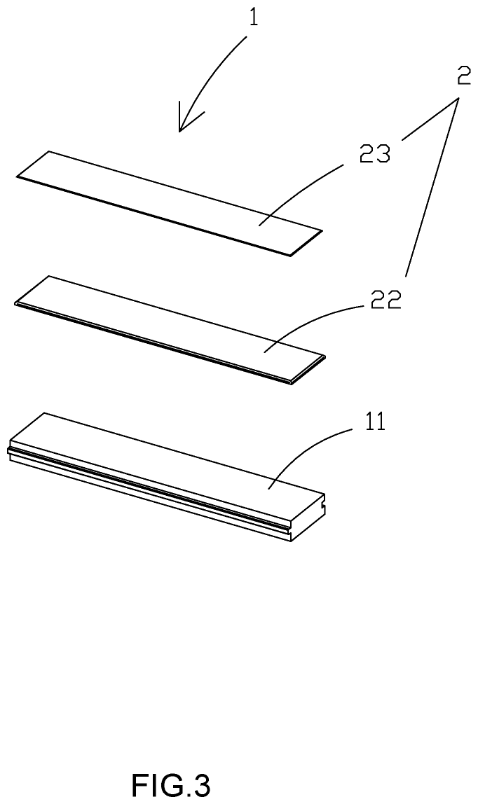

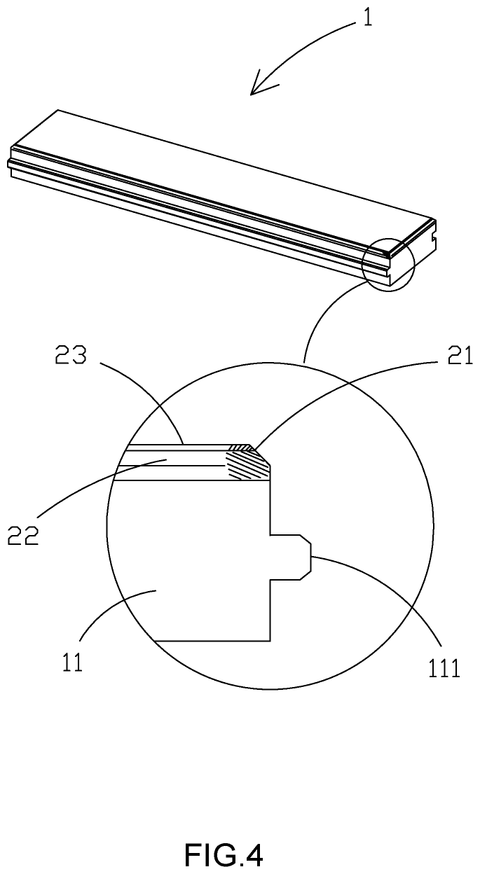

FIGS. 1 to 4 are a first pictorial view, a second pictorial view, a pictorially exploded view and a side view showing an improved beveled floor panel according to a preferred embodiment of the invention. Referring to FIGS. 1 to 4, it can be clearly seen from the figures that the invention provides an improved beveled floor panel 1 including a bottom layer 11 and a floor layer 2.

A lateral side of the bottom layer 11 has a first connection portion 111 and a second connection portion 112. The first connection portion 111 is to be connected to a second connection portion 112 of a second beveled floor panel 1, and the second connection portion 112 is to be connected to a first connection portion 111 of the second beveled floor panel 1. Preferably, a material of the bottom layer 11 is a medium density fiberboard (MDF), a solid polymer core (SPC), polyvinyl chloride (PVC), foam or laminated veneer lumber. In addition, the first connection portion 111 is a male structure, and the second connection portion 112 is a female structure to be connected to the male structure. Also, a thickness of the bottom layer 11 ranges between 1 mm and 25 mm, but this invention is not limited thereto.

The floor layer 2 is disposed on the bottom layer 11, and has four top lateral edges each formed with a bevel 21. The floor layer 2 includes a homochromatic layer 22 and a wear-resistant printing layer 23 disposed on the homochromatic layer 22. Preferably, a material of the homochromatic layer 22 is polyethylene terephthalate glycol (PETG) or acrylonitrile butadiene styrene (ABS). A material of the wear-resistant printing layer 23 is polypropylene (PP), polyvinyl chloride (PVC) or paper. In one preferred embodiment, the floor layer 2 has four top lateral edges each formed with a bevel 21. A depth of the bevel 21 ranges between 0.05 mm and 0.8 mm. A thickness of the homochromatic layer 22 ranges between 0.2 mm and 1.0 mm, and a thickness of the wear-resistant printing layer 23 ranges between 0.05 mm and 0.5 mm, but this invention is not limited thereto.

In further explanation, the homochromatic layer 22 may have one single color, which may be white, black, grey, yellow, red and any other color, and is similar to a color of the wear-resistant printing layer 23.

Using the PETG or ABS as the material of the homochromatic layer 22 has the following additional advantages. First, the three-layer structure can increase the balance degree of the floor panel. Second, the hardness and toughness of the wear-resistant printing layer 23 can be increased. Third, the weather-resistant and whitening properties of the wear-resistant printing layer 23 can be increased. Fourth, the environment protection material is satisfied. Fifth, easy processing is satisfied. Sixth, the floor panels may be made to have multiple kinds of single colors. The wear-resistant printing layer 23 is made, by way of printing, to have various colors, natural textures and totems, and is processed by wear-resistant treatment and the like.

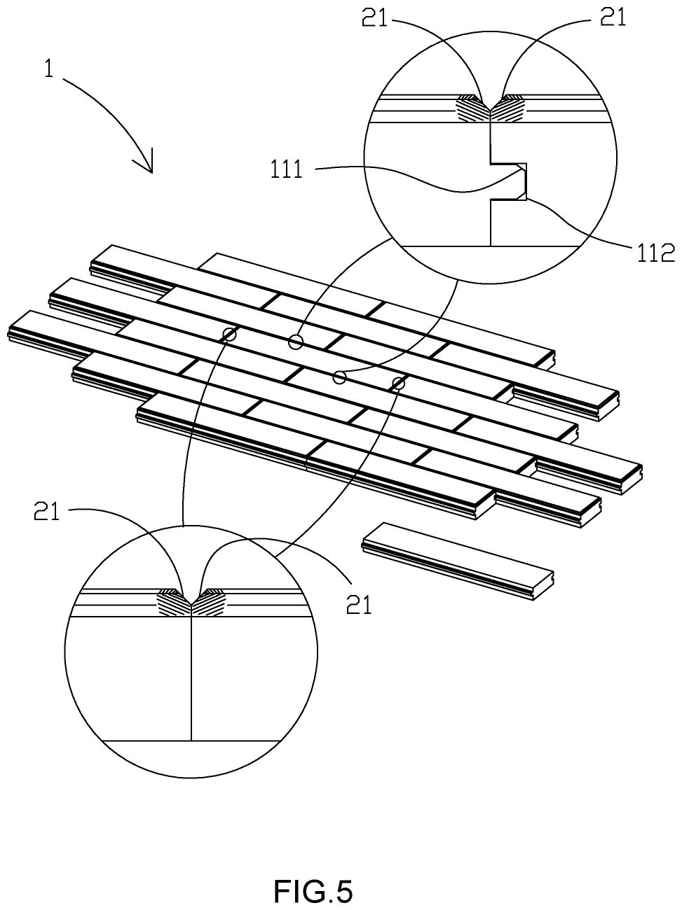

Operation conditions of the invention will be explained in the following according to the above-mentioned structure and composition design. FIG. 5 is a schematic implementation view showing the improved beveled floor panel according to the preferred embodiment of the invention. Referring also to FIG. 5, it can be clearly seen from the figure that each of the four top lateral edges of the floor layer 2 of the invention is formed with a bevel 21. That is, either the short lateral side or the long lateral side of the beveled floor panel 1 is formed with the bevel 21. A groove is formed between two bevels 21 according to the combination of multiple beveled floor panels 1. The two beveled floor panels 1 are connected together using the first connection portions 111 and the second connection portions 112. Specifically, the first connection portion 111 is a male structure, and the second connection portion 112 is a female structure connected to the male structure.

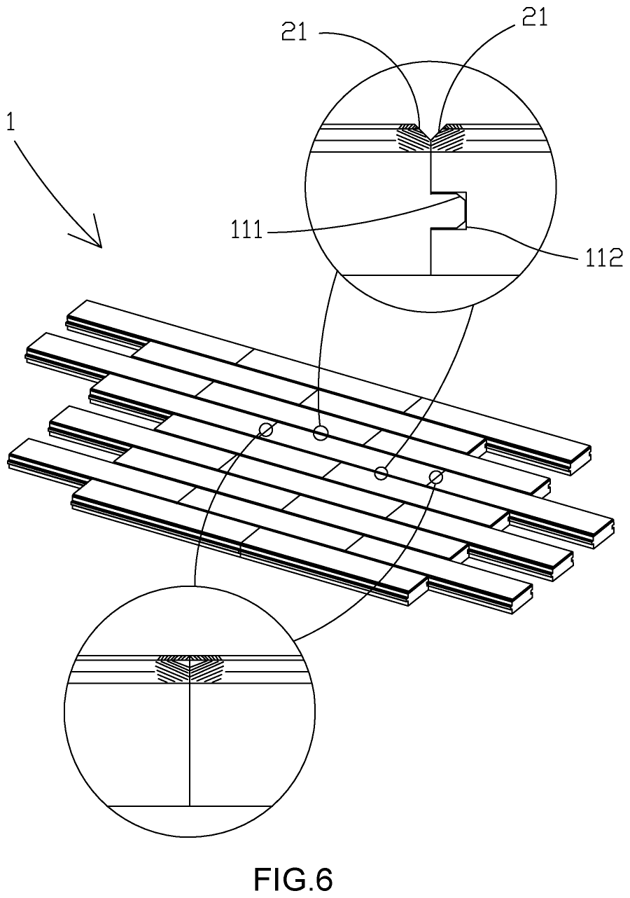

FIG. 6 is a schematic implementation view showing an improved beveled floor panel according to another preferred embodiment of the invention. Referring also to FIG. 6, it can be clearly seen from the figure that each of two top lateral edges of the floor layer 2 of the invention is formed with a bevel 21 disposed on the long lateral side. A groove is formed between two bevels 21 according to the combination of multiple beveled floor panels 1. It is to be described that the combination portion on the short lateral side has no grooved shape.

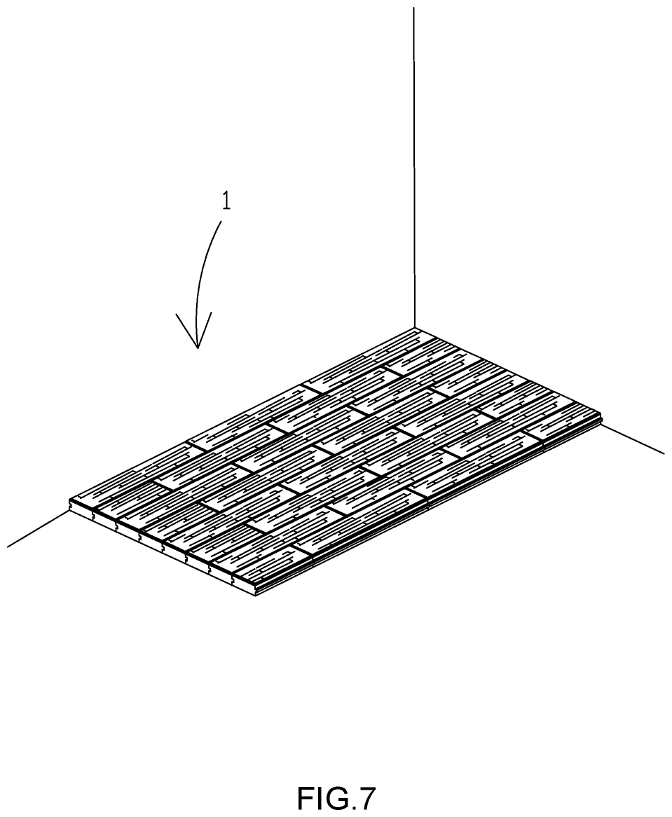

FIG. 7 is a schematic implementation view showing an improved beveled floor panel according to still another preferred embodiment of the invention. The aspect of combining the beveled floor panels 1 can be clearly seen from FIG. 7. Forming the bevels 21 on the beveled floor panel 1 of the invention has the following advantages.

(1) In the visual aspect, the three-dimensional texture of the bevel 21 makes the floor have the much more layered appearance, the solid wood imitated design is added, the texture closer to the solid wood texture is presented, the overall visual appearance of the floor also becomes smoother, and the sense of space extension and aesthetics is enhanced. (2) In the function aspect, the floor panel has the property of thermal expansion and contraction. Different floor panels have different stretchabilities. So, if there is no bevel 21, the joint tends to become uneven. The bevel 21 is designed to leave gaps at the joint between the floor panels, and functions as a buffer to reduce the step problem generated when the wood floor panels are squeezed or pushed together, so that the construction becomes more convenient. The knot at the step can also increase the durability of the corner of the floor panel and the anti-slip function of the floor panel, and lengthen the service lifetime. (3) In the safety aspect, the right angle tends to cause burrs and chippings, and the sleek design can avoid the scratch. The bevel 21 can also increase the anti-slip function of the floor panel, and the floor panel can be used in a safer manner.

In the homochromatic layer 22 of the invention, polyethylene terephthalate glycol (PETG) is adopted as the amorphous copolyester material, or the polymer of acrylonitrile butadiene styrene (ABS). Because it has many special advantages, many colors of products, each having one single color, can be produced and combined with different colors of wear-resistant printing layers 23. The bevels 21 having different widths (ranging between 0.05 mm and 0.8 mm) are formed by grinding at the panel edges, and the problem of color difference can be reduced at the seam groove between the interlocked floor panels.

So, referring to all the figures, the invention being used indeed has the following advantages as compared with the prior art. With the improved beveled floor panel of the invention, either the color difference at the seam groove of the bevel 21 can be reduced after the floor panels having different color systems have been spliced, or the problem of different colors can be reduced, and the appearance cannot be affected.

However, the descriptions are made with reference to only the preferred embodiment of the invention without limiting the claims of the invention. Therefore, any simple modifications and equivalent structural changes made according to the descriptions and drawings of the invention are still deemed as falling within the scope of the invention.

What is claimed is:

1. A beveled floor panel, comprising:
a bottom layer, wherein a lateral side of the bottom layer has a first connection portion and a second connection portion, the first connection portion is to be connected to a second connection portion of a second beveled floor panel, and the second connection portion is to be connected to a first connection portion of the second beveled floor panel; and
a floor layer, which is disposed on the bottom layer, and has two top lateral edges each formed with a bevel, wherein the floor layer comprises a homochromatic layer and a wear-resistant printing layer, and the wear-resistant printing layer is disposed on the homochromatic layer.

2. The beveled floor panel according to claim 1, wherein a material of the bottom layer is a medium density fiberboard (MDF), a solid polymer core (SPC), polyvinyl chloride (PVC), foam or laminated veneer lumber.

3. The beveled floor panel according to claim 1, wherein a material of the homochromatic layer is polyethylene terephthalate glycol (PETG) or acrylonitrile butadiene styrene (ABS).

4. The beveled floor panel according to claim 1, wherein a material of the wear-resistant printing layer is polypropylene (PP), polyvinyl chloride (PVC) or paper.

5. The beveled floor panel according to claim 1, wherein each of two additional top lateral edges of the floor layer is formed with a bevel.

6. The beveled floor panel according to claim 1, wherein the first connection portion is a male structure, and the second connection portion is a female structure connected to the male structure.

7. The beveled floor panel according to claim 1, wherein a depth of the bevel ranges between 0.05 mm and 0.8 mm.

8. The beveled floor panel according to claim 1, wherein a thickness of the bottom layer ranges between 1 mm and 25 mm.

9. The beveled floor panel according to claim 1, wherein a thickness of the homochromatic layer ranges between 0.2 mm and 1.0 mm.

10. The beveled floor panel according to claim 1, wherein a thickness of the wear-resistant printing layer ranges between 0.05 mm and 0.5 mm.
